(19) United States
(12) Patent Application Publication
(10) Pub. No.: US 2009/0218906 A1
(43) Pub. Date: Sep. 3, 2009

(54) ROTATING ELECTRIC MACHINE AND METHOD OF MANUFACTURING THE SAME

(75) Inventors: Tomohiro Adachi, Hitachi (JP); Yoshimi Mori, Mito (JP); Kenichi Nakayama, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/392,726

(22) Filed: Feb. 25, 2009

(30) Foreign Application Priority Data
Mar. 3, 2008 (JP) 2008-051511

(51) Int. Cl. H02K 1/16; H02K 15/02

(52) U.S. Cl. 310/216.069; 29/596

(57) ABSTRACT

A rotational electric machine has a stator including stator windings and a stator core having teeth defining slots in which stator coils of the stator windings can be inserted in a radial direction, and a rotor axially inserted in an axial bore of the stator and supported for rotation. Protrusions for narrowing radially inner open ends of the slots are formed in axially separate parts of radially inner axial edges of the teeth by crimping.

### BACKGROUND OF THE INVENTION

1. Field of the invention

The present invention relates to a rotating electric machine and a method of manufacturing the same.

2. Description of the Related Art

A technique for preventing coils inserted in slots of a stator from falling off the slots onto a rotor, disclosed in JP-A H11-308789 forms a coil holding mechanism by using teeth each having two axial grooves and a finger on the side of the coil with respect to a circumferential direction, and bending the finger toward the coil after inserting the coil.

The teeth used by this known technique are provided with the grooves to form fingers, and hence the sectional area of a core end is reduced and, consequently, overexcitation is liable to occur. For example, in a small multipole rotating electric machine, the circumferential length of the core end is very short. Therefore, the grooves are liable to cause magnetic flux leakage when magnetic flux density is very large.

### SUMMARY OF THE INVENTION

It is an object of the present invention to provide a rotating electric machine capable of operating at an improved efficiency by preventing the coils from falling off without reducing the effective magnetic passages of the teeth, and a method of manufacturing the rotating electric machine.

The present invention provides a rotating electric machine including a stator provided with a plurality of teeth defining slots in which stator coils can be inserted in a radial direction; and a rotor inserted in an axial bore in the stator such that a gap is formed between the stator and the rotor and supported for rotation; wherein the teeth of the stator are provided with protrusions for narrowing open ends of the slots defined by the teeth.

The rotating electric machine of the present invention is capable of operating at improved efficiency.

### BRIEF DESCRIPTION OF THE DRAWINGS

Embodiment (s) of the present invention will be described in detail based on the following figures, wherein:

FIG. 1 is a longitudinal sectional view of an induction rotating electric machine in a preferred embodiment according to the present invention;

FIG. 2 is a perspective view of a rotor included in the induction rotating electric machine shown in FIG. 1;

FIG. 3 is an exploded perspective view of the induction rotating electric machine shown in FIG. 1;

FIG. 4 is a diagrammatic view of assistance in explaining electrical connection;

FIG. 5 is a diagrammatic view showing a rotating magnetic field created by stator coils;

FIG. 6 is a diagrammatic view showing magnetic flux in a state where the rotating speed of the rotor is lower than the rotating speed of a rotating magnetic field created by a stator core;

FIG. 7 is a perspective view of the stator;

FIG. 8 is a perspective view of stator coils formed by winding a single continuous conductor and forming a stator winding;

FIG. 9 is a perspective view of coils for one phase;

FIG. 10 is an end view of the stator;

FIG. 11 is a side elevation of the stator;

FIG. 12 is an end view of a stator slot; and

FIG. 13 is a fragmentary perspective view of a laminated stator core.

### DESCRIPTION OF THE PREFERRED EMBODIMENTS

A rotating electric machine in a preferred embodiment according to the present invention is provided with windings formed by winding rectangular wires in a distributed winding. A structure described herein forms uniform magnetic passages in core teeth without locally narrowing the magnetic passages and is capable of preventing stator coils from falling off a stator core.

Although the rotating electric machine is comparatively small like an automotive driving motor, the rotating electric machine is capable of providing high output power and is built in construction that improves productivity. The stator winding of the rotating electric machine can be formed by using a conductor having a substantially rectangular cross section as well as a conductor having a substantially circular cross section. Therefore, the space ratio of the winding in a slot can be increased and hence the rotating electric machine can operate at an improved efficiency. If the winding of the conventional rotating electric machine is formed by winding a conductor having a substantially rectangular cross section, there are many parts to be electrically connected after inserting the conductor in the slots of the stator, which is disadvantageous from the viewpoint of productivity. In the embodiment described herein, coils formed by continuously winding a conductor having an insulated surface can be inserted in slots. Therefore, parts to be electrically connected are lessened, which improves productivity.

In the embodiment described herein, a first coil, namely, one of coils, is inserted deep in a slot, the distance between the first coil and a second coil, namely, the other coil, is adjusted, and then the second coil is inserted in the open side of the slot. Thus, the continuous coils can be efficiently inserted in slots to improve productivity.

In this embodiment, a lap-wound part of the continuous coils is formed by winding a continuous wire, one of the lap-wound coils, namely, a first coil, is inserted in a slot and the other coil, namely, a second coil, is inserted in a slot separated by a predetermined distance from the former slot. The first coil is disposed at a radially inner part of the slot and the second coil is disposed at a radially outer part of the slot. An end part of the coil extends outward from an inner part of the slot or extends inward from an outer part of the slot. Thus, the continuous coils are arranged regularly, the number of turns of the coils can be increased and increase in parts to be electrically connected resulting from the increase of the turns of the coils can be suppressed. The increase of the size of the rotating electric machine can be suppressed even though the number of turns of the coils is increased.

In each of the slots of this embodiment, parts of the conductor forming the coil are arranged in radially direction with respect to an axis of rotation and the conductor is arranged in a row in a circumferential direction. Therefore, the continuous coils can be comparatively easily inserted in the slots and hence productivity is improved. Since the coils are arranged such that currents of the same phase flows in the same direction in the adjacent slots and hence the rotating electric machine can be produced at high productivity. A stator winding is formed by electrically connecting stator coils each having unit coils and formed by connecting the coils for the same phase held in the adjacent slots in series. The stator winding has an effect on facilitating balancing electric characteristics.

The stator winding of the embodiment is applicable to permanent magnet rotating electric machines and induction rotating electric machines. In an embodiment described below, the induction rotating electric machine is an eight-pole induction rotating machine by way of example. When the induction rotating machine has six or more poles, such as eight poles or ten poles, the magnetic passage of the core back of a stator core can be formed in a small radial thickness. When the induction rotating machine has six or more poles, such as eight poles or ten poles, a magnetic passage in the yoke of a rotor can be formed in a small radial thickness. When the rotating electric machine is an induction motor, efficiency is lessened owing to the squirrel cage of the rotor when the number of poles of the stator is increased. Preferably, the number of poles of the rotating electric machine for the drive system of a vehicle is in the range of six to ten, desirably, in the range of eight to ten. Eight-pole rotating electric machine is most desirable. The rotating electric machine for the drive system of a vehicle is capable of producing a torque sufficient for starting an engine or for moving a vehicle in cooperation with the engine or capable of driving a vehicle for running by itself.

The rotating electric machine will be described on an assumption that the rotating electric machine is an electric motor for a hybrid car by way of example. The electric motor embodying the present invention for the hybrid car has both a driving function of a driving motor for driving the wheels and a power generating function of a generator for power generation. Either of the driving and the power generating function is selectively used according to the running condition of the hybrid car.

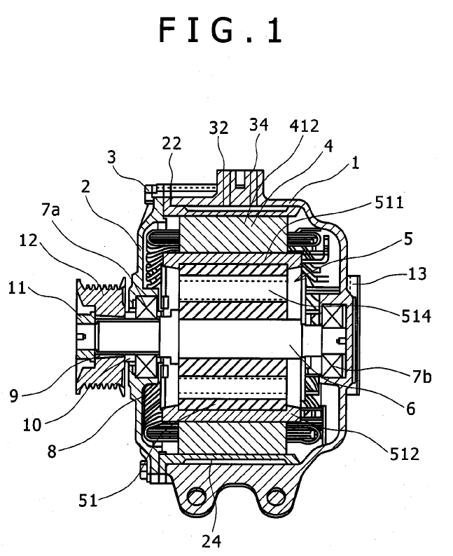

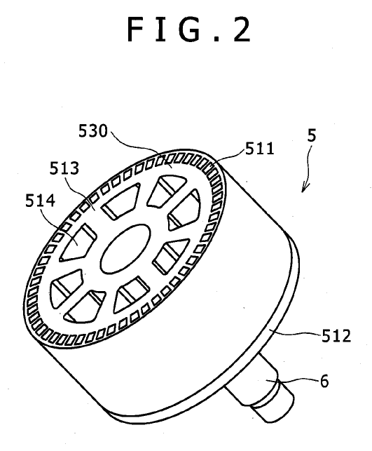

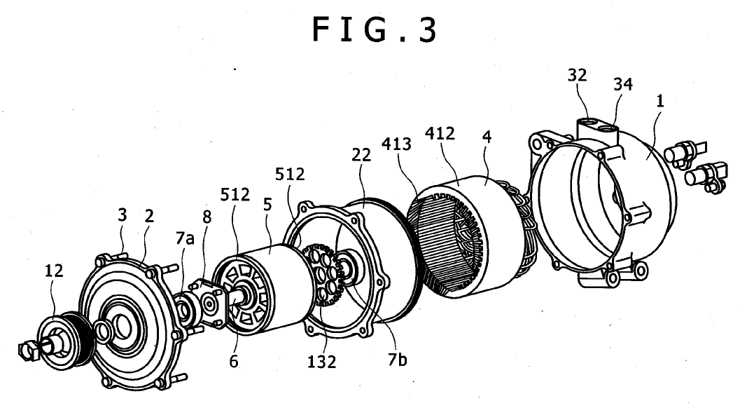

FIG. 1 is a longitudinal sectional view of an induction rotating electric machine in a preferred embodiment according to the present invention, FIG. 2 is a perspective view of a rotor included in the induction rotating electric machine shown in FIG. 1 and FIG. 3 is an exploded perspective view of the induction rotating electric machine shown in FIG. 1.

The induction rotating electric machine has a housing 1 having the shape of a bottomed cylinder having one open axial end, and a cover 2 closely covering the open axial end of the housing 1. A water passage forming member 22 is fitted in the housing 1. The cover 2 is pressed against one end of the water passage forming member 22 to hold the water passage forming member securely in the housing 1. Thus a water passage 24 is formed between the housing 1 and a stator 4. Cooling water is supplied through a cooling water inlet 32 into the water passage 24 and is discharged through a cooling water outlet 34 to cool the induction rotating electric machine. The cover 2 is fastened to the housing with, for example, six bolts 3.

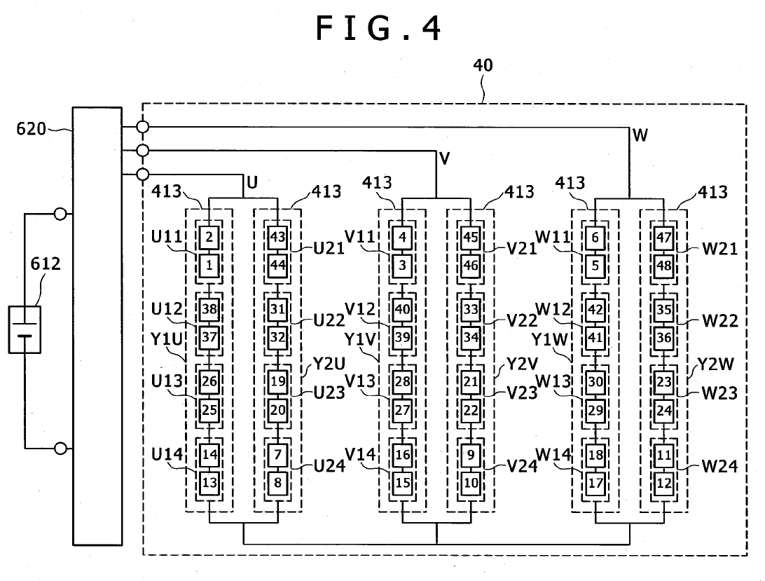

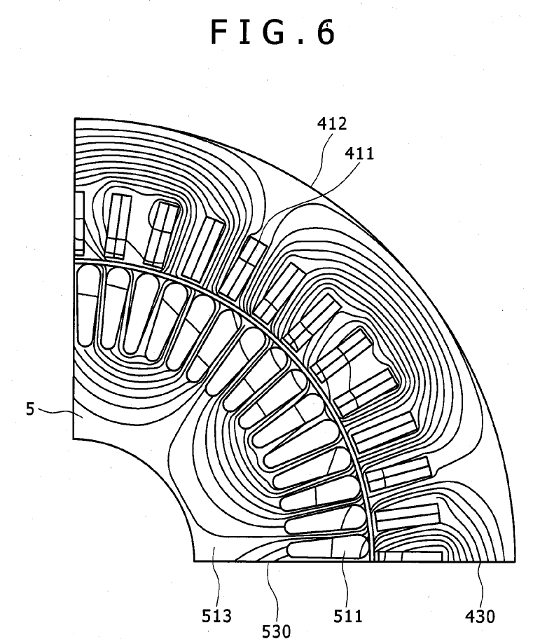

The water passage forming member 22 is fitted in the housing 1. The water passage forming member 22 and the stator 4 are combined securely by shrink fit. The stator 4 includes a stator core 412 provided with a plurality of slots 411 formed in its circumference at equal circumferential intervals as shown in FIG. 6, and stator windings 40 for three phases formed in the slots 411. In the induction rotating electric machine in this embodiment, the stator core 412 has eight poles and forty-eight slots 411. The stator windings 40 are star-connected. Each of the phases is 2Y-connection formed by connecting a pair of stator coils 413 in parallel as shown in FIG. 4.

A rotor 5 is placed in the bore of the stator core 412 coaxially with the stator core 412 with a small gap formed between the inside surface of the stator core 412 and the circumference of the rotor 5. The rotor 5 is fixedly mounted on a shaft 6 and rotates together with the shaft 6. Opposite ends of the shaft 6 are rotatably supported in ball bearings 7a and 7b on the cover 2 and the housing 1, respectively. The ball bearing 7a is fixed to the cover 2 by a substantially square fixing plate 8. The bearing 7b is fixedly fitted in a recess formed in the bottom wall of the housing 1. The rotor 5 rotates relative to the stator 4. A pulley 12 is mounted on a sleeve 9 mounted on an end part on the side of the cover 2 of the shaft 6, is spaced from the ball bearing 7a by a spacer and is fixed with a nut 11. The rotational driving force of the shaft 6 is delivered through the pulley 12 or a rotational driving force is transmitted through the pulley 12 to the shaft 6. The outside surface of the sleeve 9 and the inside surface of the center bore of the pulley 12 are tapered such that the pulley 12 can be firmly locked to the sleeve 9 by screwing the nut 11 tight on a threaded part of the shaft 6 for rotation together with the shaft 6.

The rotor 5 is a squirrel cage type rotor including axial conducting bars 511 arranged at equal circumferential intervals, and a pair of end rings 512 short-circuiting the opposite ends of the conducting bars 511, respectively. The conducting bars 511 of a magnetic material are embedded in the periphery of a rotor core 513. FIG. 2 is a cross section of the rotor 5 illustrating the relation between the conducting bars 511 and the rotor core 513. In FIG. 2, the end ring 512 and a part of the shaft 6 on the side of the pulley 12 are not shown.

The rotor core 513 is a laminated core built up from electromagnetic steel laminations of a thickness in the range of about 0.05 to about 1 mm stamped out from an electromagnetic steel sheet or formed by etching an electromagnetic steel sheet. As shown in FIGS. 2 and 3, substantially fan-shaped openings 514 are formed at equal angular intervals in the body of the rotor core 513 to form the rotor core 513 in a light weight. Spaces for receiving the conducting bars 511 are formed in a peripheral part of the rotor core 513. The conducting bars 511 are in a part of the rotor core 513 on the side of the stator, and rotor yoke 530 for forming a magnetic circuit is on the inner side of the conducting bars 511.

In this embodiment, the stator 4 is provided with eight-pole windings. The radial thickness of the magnetic circuit formed in the rotor yoke 530 is small as compared with that of two-pole and four-pole induction rotating electric machines. Although the thickness of the magnetic circuit can be reduced by increasing the number of poles beyond eight, the output and efficiency decrease when the number of the poles is increased to twelve or above. Therefore, a desirable number of poles of a rotating electric machine for starting an engine and driving a vehicle is between six and ten, more desirably, eight or ten.

The conducting bars 511 and the end rings 512 of the rotor 5 are made of aluminum and are incorporated into the rotor core 513 by die casting. The end rings 512, put respectively on the opposite ends of the rotor core 513, protrude axially outward from the opposite ends of the rotor core 513, respectively.

A detection rotor 132 is placed on a part of the rotor 5 on the side of the bottom wall of the housing 1. A rotation sensor 13 detects teeth formed on the detection rotor 132 and provides electric signals carrying the rotating speed and angular position of the rotor 5. The sensor may be a resolver.

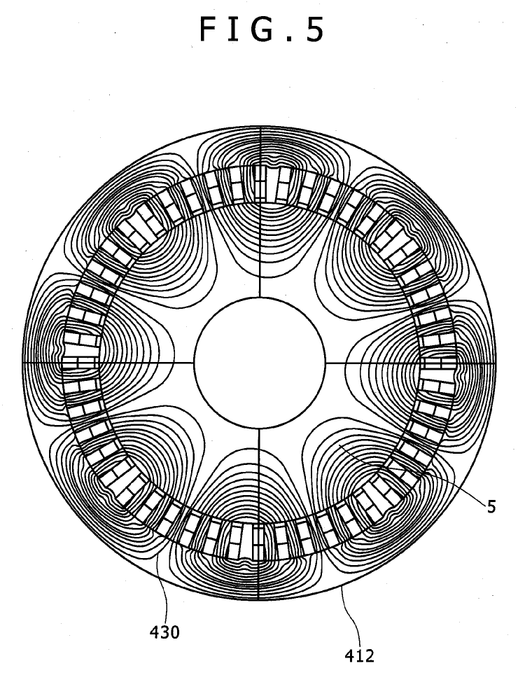

The operation of the induction rotating electric machine in this embodiment will be described with reference to FIGS. 1 to 6. FIG. 4 is a diagrammatic view of assistance in explaining electrical connection, FIG. 5 is a diagrammatic view showing a rotating magnetic field created by stator windings 40 and FIG. 6 is a diagrammatic view showing magnetic flux in a state where the rotating speed of the rotor provided with the conducting bars 511 is lower than the rotating speed of a rotating magnetic field created in the stator core 412.

The power running operation of the induction rotating electric machine for driving the wheels and the engine will be described. Referring to FIG. 4, the dc terminals of an inverter 620 are electrically connected to a high-voltage secondary battery 612 that provides a voltage in the range of, for example, 100 to 600 V. The ac terminals of the inverter 620 are electrically connected to the stator windings 40. Each of the stator windings 40 for the phases has stator coils 413 placed in parallel.

The secondary battery 612 supplies dc power to the inverter 620 for a power running operation and the inverter 620 supplies ac power to the stator coils 413 of the three-phase stator windings 40. Consequently, a rotating magnetic field rotating at a rotating speed corresponding to the frequency of the ac power is created in the stator core 412. As shown in FIG. 5, magnetic flux extends through a magnetic path formed by the rotating magnetic field created in the rotor 5. FIG. 5 shows the rotating magnetic field created by the stator windings 40. The stator windings 40 are wound by, for example, an eight-pole distributed winding. FIG. 5 shows a state where the influence of the rotor is eliminated obtained through the simulation of a general core supposed to be not provided with conducting bars. A core back 430 formed on the radially outer side of the slots of the stator core 412 forms a magnetic circuit for the rotating magnetic field. In this simulation, the radial thickness of the magnetic circuit on the core back 430 is thin because the stator windings 40 are wound on poles as many as eight poles. The radial thickness of the magnetic circuit on the rotor 5 also is thin. The rotating magnetic field shown in FIG. 5 rotates at a rotating speed corresponding to the frequency of the ac power supplied to the stator windings 40.

Referring to FIG. 4, the inverter 620 produces an ac current necessary for producing a torque required of the induction rotating electric machine and supplies the ac current to the stator windings 40. When the rotating speed of the rotor 5 is lower than that of the rotating magnetic field, the conducting bars 511 cross the rotating magnetic field created in the stator core 412 and currents flow through the conducting bars 511 and torque acts on the rotor 5 according to Fleming's left-hand rule to rotate the rotor 5. The difference between the respective rotating speeds of the rotor 5 and the rotating magnetic field created in the stator 4 influences the magnitude of the torque. Therefore, the difference, namely, slip, needs to be properly controlled. The rotating speed of the rotor 5 is measured by the rotation sensor 13 and the switching frequency of the inverter 620 is controlled on the basis of the output signal of the rotation sensor 13 to control the frequency of the ac current supplied to the stator 4.

FIG. 6 shows the result of simulation showing magnetic flux in a state where the rotating speed of the rotor 5 provided with the conducting bars 511 is lower than the rotating speed of a rotating magnetic field created in the stator core 412. The rotor 5 rotates counterclockwise. Magnetic flux produced by the stator windings 40 placed in the slots 411 extends through a magnetic circuit including the core back 430, and the rotor yoke 530 of the rotor core 513. The magnetic flux in the rotor core 513 is shifted on the delayed side with respect to the rotating direction of the rotor 5. Since the poles of the stator windings are as many as eight poles, magnetic flux density in a part on the side of the conducting bars 511 is high and magnetic flux density on the side of the rotor shaft is low in the rotor yoke 530.

The power generating operation of the induction rotating electric machine will be described. When the induction rotating electric machine operates as a generator, the rotor 5 is rotated by torque applied to the pulley 12 at a rotating speed higher than the rotating speed of the rotating magnetic field created in the rotor core 412. When the rotating speed of the rotor 5 exceeds the rotating speed of the rotating magnetic field, the conducting bars 511 cross the rotating magnetic field. Consequently, braking force acts on the rotor 5. Power is generated in the stator windings 40 by the agency of the braking force. Thus power is generated. When the frequency of the ac power generated by the inverter 620 is lowered to reduce the rotating speed of the rotating magnetic field created in the stator core 412 below the rotating speed of the rotor 5, dc power is supplied to the secondary battery 612 from the inverter 620. Since power generated by the induction rotating electric machine is based on the difference between the rotating speed of the rotating magnetic field and that of the rotor 5, generated power can be controlled by controlling the operation of the inverter 620. When loss in the induction rotating electric machine and ineffective power is neglected, power is supplied through the inverter 620 to the induction rotating electric machine from the secondary battery 612 when the rotating speed of the rotating magnetic field created in the induction rotating electric machine is raised beyond the rotating speed of the rotor 5. Consequently, the induction rotating electric machine operates as a motor. When the rotating speed of the rotating magnetic field created in the induction rotating electric machine is equal to the rotating speed of the rotor 5, any power is not transmitted between the secondary battery 612 and the induction rotating electric machine. When the rotating speed of the rotating magnetic field is lower than the rotating speed of the rotor 5, power is supplied through the inverter 620 to the secondary battery 612 from the induction rotating electric machine. However, loss in the induction rotating electric machine and ineffective power are practically not negligible. Therefore, power transmission from the secondary battery 612 to the induction rotating electric machine stops when the rotating speed of the rotating magnetic field created in the induction rotating electric machine decreases slightly below the rotating speed of the rotor 5.

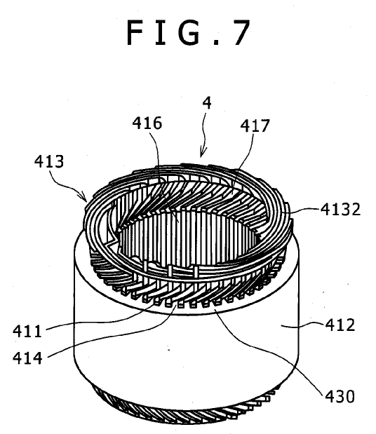

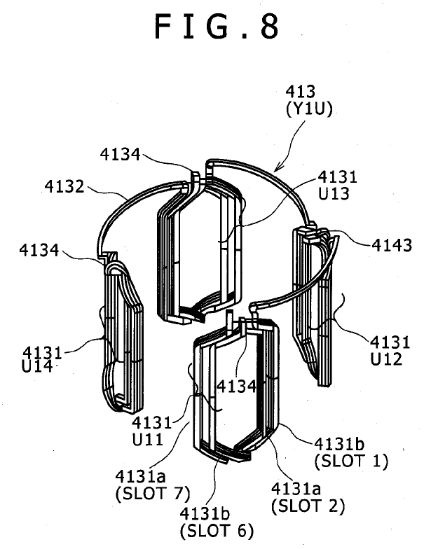

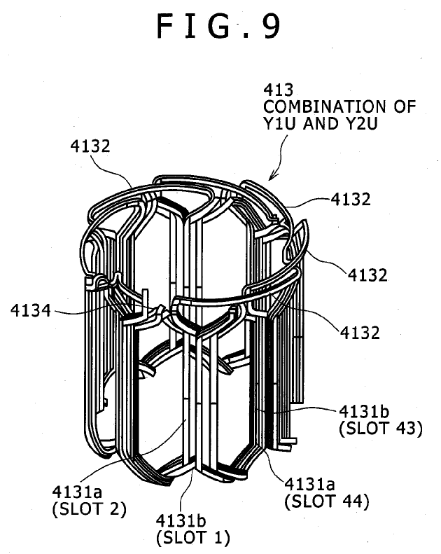

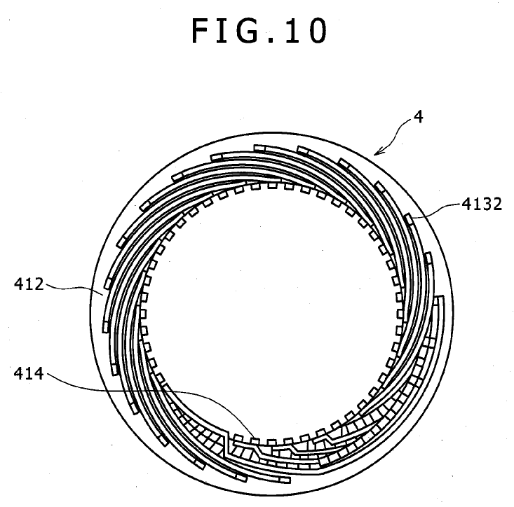

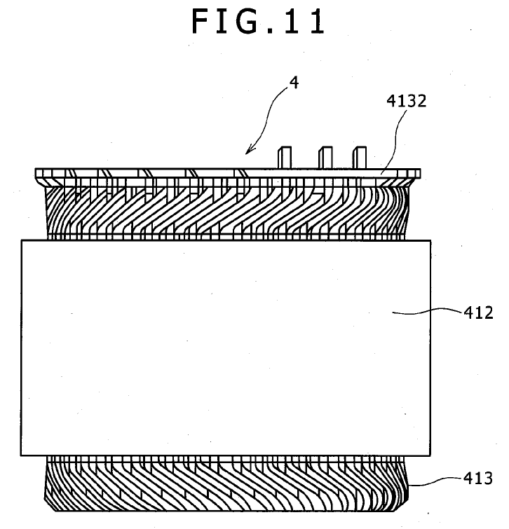

The stator 4 will be described in detail with reference to FIGS. 4 and 7 to 11. FIG. 7 is a perspective view of the stator 4, FIG. 8 is a perspective view of the stator coil 413 formed by winding a single insulated conductor, FIG. 9 is a perspective view of stator coil 413 for one phase, FIG. 10 is an end view of the stator 4 and FIG. 11 is a side elevation of the stator 4.

The stator 4 shown in FIG. 7 includes the stator core 412 provided with forty-eight slots 411 arranged in a circumferential direction at equal intervals, and the plurality of stator coils 413 forming the stator windings 40 placed in the slots 411. The stator core 412 is built up from electromagnetic steel laminations of a thickness in the range of about 0.05 to about 1 mm stamped out from an electromagnetic steel sheet or formed by etching an electromagnetic steel sheet. The slots 411 are extended radially. In this embodiment, the number of the slots 411 is forty-eight. Teeth 414 are formed between the adjacent ones of the slots 411. The teeth 414 are formed integrally with the core back 430. Each slot 411 has an open inner end. The stator coil 413 of the stator winding 40 is inserted through the open inner end in the slot 411. The width of the open inner end of the slot 411 in a circumferential direction is substantially equal to or slightly greater than that of a slot holding part of the slot 411. The slots 411 are open slots. A holding member 416 is attached to the inner end of each of the teeth 414 to prevent the stator coil 413 inserted in the slot form coming off the slot 411. The holding members 416 are made of a nonmagnetic material, such as a resin, or a nonmagnetic metal. The holding members 416 are fitted axially in axial holding grooves 417 formed in circumferentially opposite side surfaces of the teeth 414, respectively.

The stator coils 413 forming the stator windings 40 will be described with reference to FIGS. 8 and 9. This embodiment is provided with stator windings 40 for three phases. First, one of the stator windings 40 for one of the three phases will be described. The stator coils 413 are formed by winding an insulated rectangular conductor having a substantially rectangular cross section. The conductor extends in the stator coil 413 such that the longer sides thereof extend in the circumferential direction and the shorter sides thereof extend in the radial direction. As mentioned above, the conductor of the stator coils 413 is coated with an insulating coating.

The connections in the stator winding 40 will be described with reference to FIG. 4 before description in connection with FIG. 8. The stator winding 40 includes the two paralleled stator coils 413 for each phase and has two Y-connected circuits Y1 and Y2. The Y-connected circuit Y1 includes a U-phase winding Y1U, a V-phase winding Y1V and a W-phase winding Y1W. The Y-connected circuit Y2 includes a U-phase winding Y2U, a V-phase winding Y2V and a W-phase winding Y2W. The Y-connected circuits Y1 and Y2 are paralleled and their neutral points are connected.

The U-phase winding Y1U is built by connecting coils U11, U12, U13 and U14 in series. The U-phase winding Y2U is built by connecting coils U21, U22, U23 and U24 in series. The V-phase winding Y1V is built by connecting coils V11, V12, V13 and V14 in series. The V-phase winding Y2V is built by connecting coils V21, V22, V23, and V24 in series. The W-phase winding Y1W is built by connecting coils W11, W12, W13 and W14 in series. The W-phase winding Y2W is built by connecting coils W21, W22, W23 and W24 in series. As illustrated in FIG. 4, each of the U11 to W24 has two coils. For example, the coil U11 is built by connecting the two coils 2 and 1 in series. The numbers 2 and 1 indicating the coils 1 and 2 are slot numbers assigned to the stator slots. That is, the coil U11 includes the coils inserted in the slots Nos. 2 and 1, respectively, and connected in series. Similarly, the coil U12 includes the coils inserted in the slots No. 37 and 38, respectively, and connected in series. Thus the numbers indicating the coils shown in FIG. 4 corresponds to the numbers of the stator slots. The coil W24 includes the coils inserted in the slots Nos. 11 and 12 and connected in series. It is important that the coils connected in series are inserted in the adjacent slots, respectively. Such an arrangement of the coils facilitates manufacture and has an effect on suppressing the pulsation of torque. Winding of the coils will be described later.

The windings Y1U, Y1V, Y1W, Y2U, Y2V and Y2W are the same in construction and hence the stator winding Y1U will be described by way of example with reference to FIG. 8.

The U-phase winding Y1U will be described as an example of the stator coils 413. The stator winding Y1U is built by connecting the coils U11, U12, U13 and U14 in series. The coils U11, U12, U13 and U14 are arranged at equal angular intervals of 90°. The coil U11 has the two coils 4131a and 4131b. The coil 4131a is wound through a radially inner part of the slot No. 2 and a radially outer part of the slot No. 7. The coil 4131a is wound in three loops across the slots Nos. 2 and 7 in this embodiment. Since the coils are formed by coiling a continuous conductor, any connecting work is not needed in forming the coil U11.

The coil 4131b of the coil U11 is wound through a radially inner part of the slot No. 1 and a radially outer part of the slot No. 6. The coil 4131b is wound in three loops across the slots Nos. 1 and 6. Each of the coils 4131a and 4131b is wound across the two slots, extends in the radially inner part of one of the two slots and extends in the radially outer part of the other slot. The coils 4131a and 4131b are connected in series by a coil connecting wire 4134. The coil connecting wire 4134 is a part of the conductor forming the coils 4131a and 4131b and hence any connecting work is not needed for connecting the coils 4131a and 4131b. The coils 4131 each wound across the two slots as mounted on the stator core 412 have a substantially hexagonal shape. Each of the coils 4131 is wound so as to extend in the radially inner part of one of the two slots and in the radially outer part of the other slot. The interval between the two slots Nos. 2 and 7 and the interval between the two slots Nos. 1 and 6 are dependent on the number of the slots 411 of the stator core 412 and the number of poles.

As mentioned above, the coils 4131a and 4131b are formed by winding one continuous conductor. Therefore, parts requiring connecting work can be reduced. The coils 4131a and 4131b and the connecting wire 4134 can be formed by one continuous conductor. Although the number of turns of the conductor forming the stator windings 413 is large in this embodiment, increase in parts requiring connecting work is suppressed.

The four coils U11, U12, U13 and U14 each of a set of the two coils 4131a and 4131b are disposed at four positions arranged at equal angular intervals of 90° in this embodiment. An innermost loop of the set of the coils 4131a and 4131b and an outermost loop of another set of the coils 4131a and 4131b are connected end to end by a connecting wire 4132. Since the innermost loop of the set of the coils 4131a and 4131b and the outermost loop of another set of the coils 4131a and 4131b are formed continuously by winding a single conductor in this embodiment. The connecting wires 4132 are extended only on one axial end of the stator 4 and each of the connecting wires 4132 extends from a radially outer part toward a radially inner part of the stator core 412.

The one winding shown in FIG. 8 is half the stator winding for one phase. The stator winding for one phase is built by arranging the winding Y1U and the winding Y2U of the same construction shown in FIG. 8 at an interval of a mechanical angle of 450 as shown in FIG. 9. Thus, the sets each of the coils 4131a and 4131b are arranged at an interval of a mechanical angle of 45°. The coil 4131a of the coil U11 is disposed in the radially inner part of the slot No. 2 and the coil 4131b of the coil U11 is disposed in the radially inner part of the slot No. 1. The coil 4131a of the coil U21 spaced apart by the mechanical angle of 45° from the coil U11 extends in a radially inner part of the slot No. 44 and a radially outer part of the slot No. 1. The coil 4131b of the coil U21 extends in a radially inner part of the slot No. 43 and a radially outer part of the slot No. 48.

The stator coils 413, namely, coil assemblies, shown in FIG. 9 for three phases are arranged so as to be displaced by 15° and 30° in a circumferential direction. Thus, the stator coils 413 for three phases having a few parts requiring connecting work can be incorporated into the stator core 412. Since each of the connecting wires 4132 of the coil assembly is extended between an radially outer part and a radially inner part of the stator core 412 as shown in FIG. 10, the connecting wires 4132 are extended in a substantially spiral pattern. Other connecting wires, not the coils connected to the connecting wires 4132, need to be connected to the ends of the coils by TIG welding or the like to form the neutral point of the Y-connected circuit. Each of the connecting wires connecting the coils to the neutral point is extended between a radially outer part and a radially inner part of the stator core 412. Thus, the stator coils 413 are regularly arranged, space can be effectively used and the induction rotating electric machine can be compactly built.

The coil V11 is shifted through a mechanical angle of 15° from the coil U11. Therefore, the coil V21 of V2 is shifted through a mechanical angle of 45° from a reference position corresponding to the coil V11 shifted through a mechanical angle of 15° from the reference position corresponding to the coil U11. Since the positions of all the coils for the phase V are determined with reference to the position of the coil V11, namely, a reference position, the coils of the phase V are shifted through a mechanical angle of 15° from the coils for the U phase. Similarly, the coil W11 is shifted through a mechanical angle of 30° from the coil U11. Therefore, all the coils for the phase W are shifted through a mechanical angle of 30° from the coils for the phase U.

Since the connecting wires 4132 and one axial end of the stator 4 are in substantially the same plane as shown in FIG. 11, coil ends can be shortened. In this embodiment, the connecting wires are arranged regularly on the outer side of the coil ends with respect to a rotating direction and hence the induction rotating electric machine can be built in a small size. The reliability of electrical insulation can be ensured. Recent automotive rotating electric machines, in particular, use high working voltages. Many automotive rotating electric machines use high working voltages above 100 V and some use a high working voltage of 400V or 600 V. Thus, the reliability of electrical insulation of the conductors forming the stator windings from each other is important.

The coil 4131a and the coil 4131b each formed by coiling a conductor are connected by the coil connecting wire 4134. The connecting wire is extended on the outer side of the coil connecting wire 4134. The connecting wires are arranged regularly. As mentioned above, the induction rotating electric machine can be built in a small size and the reliability of electrical insulation can be ensured.

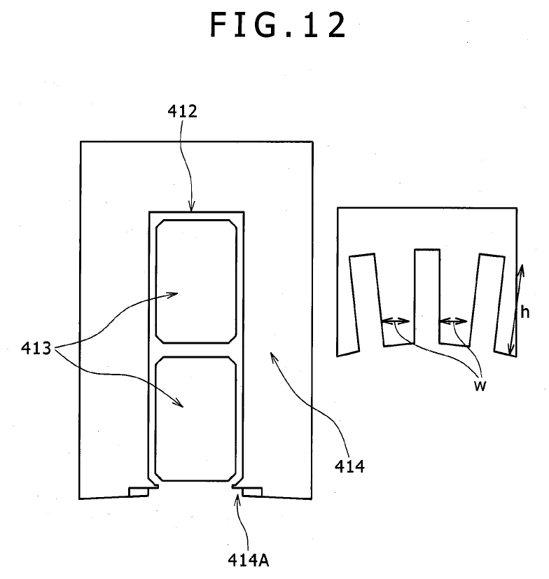

The shape of the stator slots of the induction rotating electric machine in this embodiment will be described with reference to FIG. 12. In each of the teeth 414 of the stator core, the width, namely, a circumferential dimension, of a radially inner part is smaller than that of a radially outer part; that is the teeth 414 are tapered radially inward.

Edges of the adjacent teeth 414 facing the slot are crimped to form protrusions 414A at the open end of the slot 411 after inserting the stator coil in the slot 411 by a generally know crimping method, whose description will be omitted.

The protrusions 414A prevent the stator coils 413 from coming off the slots 411. The circumferential dimension of the protrusions 414A is dependent on the size of the gap between each of the opposite side surfaces of the slot 411 and the stator coil and is on the order of 0.5 mm. When the stator coils 413 are formed by winding a conductor in a lap winding or a wave winding the rectangular conductor, the coil of each stator coils 413 is disposed in the slot 411 with one of the two straight parts thereof extended in a radially inner part of the slot 411 and the other straight part extended in a radially outer part of the slot 411. Therefore, the coils are held immovably and it is hardly possible that the coils of the stator coils 413 come off the slots 411 into the gap. However, when the induction rotating electric machine is mounted on a vehicle, it is possible that the coils are caused to come off the slots into the gap by vibrations and aging. The protrusions 414A having a circumferential dimension on the order of 0.5 mm can satisfactorily prevent the coils from coming off the slots into the gap due to the foregoing causes.

The protrusions 414A may be extended through the axial length of the stator core 412. From the viewpoint of productivity, the protrusions 414A may be formed only at several positions, such as a middle position and the axial end positions.

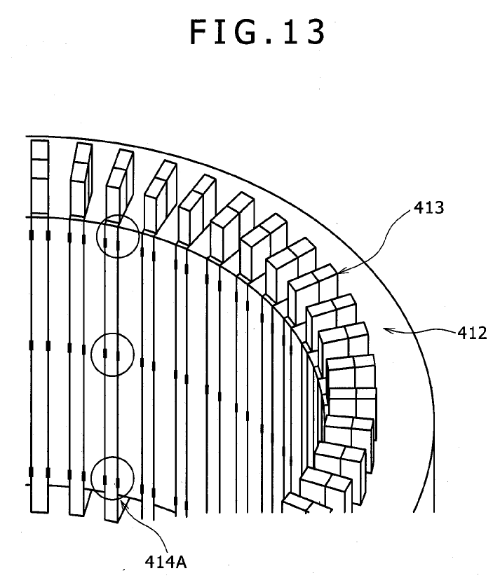

Referring to FIG. 13, the teeth 414 have a uniform width W and do not have a locally narrowed part. Therefore, local overexcitation does not occur and the magnetic flux is distributed uniformly in the teeth 414. Since the depth h of the slots 411 may be small, leakage flux in the slots can be reduced and the induction rotating electric machine has an improved ability.

The teeth 414 are provided with the protrusions protruding into the open ends of the slots 411. As shown in FIG. 13, the protrusions 414A are formed in axially separate parts in the teeth 414 so as to protrude into the open ends of the slots 411 and other parts of the teeth 414 are formed such that the coils can be radially inserted in the slots 411. That is, it is preferable that the protrusions 414A are formed in axially separate parts of the teeth 414 such that parts of the slot 411 corresponding to other parts not provided with the protrusions 414A of the teeth 414 have a width that allows the coil of the stator coil 413 to be inserted in the slot 411. In FIG. 13, the three protrusions 414A are formed at three axially separate positions, respectively. The three protrusions 414A formed in three parts of each of the opposite edges of the adjacent teeth 414 hold the coil of the stator coil 413 at a middle part and axially end parts of the coil of the stator coil 413, respectively, and can exercise a well-balanced holding function. The number of parts of the edge of each of the teeth 414 in which the protrusions 414A are formed is not limited to three. Parts not provided with the protrusions of the teeth 414 have greater effective magnetic paths because the magnetic paths are not narrowed by crimping. The stator core 412 is a laminated core built up from steel laminations of the same dimensions stamped out from a steel sheet.

The present invention is applicable to rotating electric machines for all kinds of uses. The rotating electric machines include electric motors and generators. The stator coils may be formed by winding, for example, a rectangular conductor in a distributed winding. Since short-pitch winding is applicable to a lap winding regardless of the number of poles and the number of slots, a lap winding is widely used and is suitable for application to this embodiment.

For example, when the slots are fully open to insert the rectangular conductor through the gap surface into the slot, it is possible that the stator coil inserted in the slot comes off the slot into the gap. Wedges are used to hold the stator coil securely in the slot. A groove is formed in the side surfaces of the tooth facing the slot. A wedge is driven axially into the groove after inserting the stator coil in the slot. No problem arises in a large rotating electric machine even if grooves are formed in the core teeth thereof to fit wedges therein because the core teeth have a sufficiently big width. A small electric motor, such as a rotating electric machine for vehicles, is provided with very narrow core teeth. In such a small electric motor, overexcitation occurs in the surfaces of the core teeth and leakage flux increases to affect adversely to the performance of the electric motor. Since there are only few dimensional restrictions on a large electric motor, coil ends can be formed in a sufficient coil end length and short-pitch winding can be employed regardless of the number of poles and the number of slots. Therefore, lap winding a rectangular conductor in a lap winding is preferable.

Severe dimensional restrictions are placed on the electric motor for a vehicle. Therefore, it has been usual to use a round wire to reduce the coil end length to the least possible extent. Recently, a rectangular wire is prevalently used to increase the space ratio of copper in a slot and hence the coils of an electric motor for a vehicle can be wound in a lap winding. On the other hand, the construction of the stator is complicated when the slots are opened toward the gap to insert the stator coils through the open ends of the slots in the slots, circumferentially wide grooves are formed in the side surfaces of the teeth and wedges are driven axially into the grooves after inserting the stator coils in the slots. When the grooves are formed in the core teeth for the wedges, the thickness of the core teeth is reduced greatly, overexcitation occurs in the narrow parts of the core teeth and leakage flux increases to affect adversely to the performance of the electric motor. When the wedges are used for fastening the stator coils, the depth of the slots is increased and the thickness of the core back is reduced, which increases leakage flux.

When grooves are formed in the teeth to form fingers, sections of magnetic paths in end parts of the teeth reduce and overexcitation is liable to occur. In some small mulitipolar electric motor, such as an electric motor for a vehicle, end parts of the teeth have a small thickness, namely, a circumferential size, in the range of, for example, about 2 to about 3 mm. If the magnetic flux density in the end parts of the teeth is above 2.0 T, the grooves are liable to increase leakage flux. Since two types of laminations, namely, laminations provided with a finger and those not provided with a finger, are necessary, the number of parts increases and costs of stamping dies increases.

The induction rotating electric machine in this embodiment does not need any wedges and grooves for wedges. Therefore, the core teeth have a uniform width, local overexcitation does not occur and the deterioration of performance due to leakage flux can be prevented.

In the induction rotating electric machine, the conductors of the windings can be placed in spaces which are otherwise occupied by the wedges. Consequently, the space ratio of the windings is increased, a thermal advantage is available and hence the induction rotating electric machine has high output capacity. When the depth of the slots is reduced to form shallow slots instead of increasing the space ratio of the conductors of the windings, leakage flux can be reduced and the ability can be improved.

Omission of the wedges reduces the number of parts and the cost.

The protrusions formed by crimping prevent the coils from coming off the slots. Since the total sectional area of the magnetic paths in the end parts of the teeth does not change even if the protrusions are formed by crimping, the magnetic flux density is not changed by crimping.

It should be understood by those skilled in the art that various modifications, combinations, sub-combinations and alterations may occur depending on design requirements and other factors insofar as they are within the scope of the appended claims or the equivalents thereof.

What is claimed is:

1. A rotating electric machine comprising:
a stator including a stator core provided with teeth defining a plurality of slots in which stator coils can be inserted in a radial direction; and
a rotor inserted in a bore in the stator such that a gap is formed between the stator and the rotor and supported for rotation;
wherein the teeth of the stator are provided with protrusions for narrowing open ends of the slots defined by the teeth.

2. The rotating electric machine according to claim 1, wherein axially separated parts of radially inner edges of the teeth of the stator are provided with the protrusions for narrowing the adjacent slots, and parts of radially inner edges of the teeth of the stator other than the parts in which the protrusions are formed are formed such that the coils can be radially inserted in the slots.

3. The rotating electric machine according to claim 1, wherein the protrusions are formed by deforming parts of a stator core included in the stator.

4. The rotating electric machine according to claim 1, wherein the protrusions are formed by crimping the parts of the radially inner edges of the teeth so as to protrude into the slots, respectively.

5. The rotating electric machine according to claim 1, wherein the teeth are tapered radially inward.

6. The rotating electric machine according to claim 1, wherein the protrusions hold the coils in the slots.

7. The rotating electric machine according to claim 1, wherein the circumferential surfaces of the teeth are flat.

8. The rotating electric machine according to claim 1, wherein the protrusions are formed in three parts at a middle position and axial end positions in each of the radially inner edges of the teeth.

9. The rotating electric machine according to claim 1, wherein the stator core is a laminated core built up from steel laminations of the same size stamped out from a steel sheet.

10. The rotating electric machine according to claim 9, wherein the thickness of the steel laminations is in the range of 0.05 to 1.0 mm.

11. The rotating electric machine according to claim 1, wherein the stator coils are formed by winding a rectangular wire.

12. The rotating electric machine according to claim 1, wherein the stator coils are wound on the stator core in a distributed winding.

13. The rotating electric machine according to claim 1, wherein the stator coils are wound on the stator core in a lap winding.

14. The rotating electric machine according to claim 1, wherein the stator coils are wound on the stator core in a wave winding.

15. The rotating electric machine according to claim 1, wherein the stator coils are wound on the stator core in a concentric winding.

16. A method of manufacturing a rotating electric machine including a stator including a stator core provided with teeth defining a plurality of slots in which stator coils can be inserted in a radial direction, and a rotor inserted in a bore in the stator such that a gap is formed between the stator and the rotor and supported for rotation; said method comprising the steps of:
inserting the stator coils in a radial direction in the slots; and
forming protrusions for narrowing radially inner open ends of the slots in axially separate parts of radially inner axial edges of the teeth by crimping.
